(19) United States
(12) Patent Application Publication
(10) Pub. No.: US 2023/0250588 A1
(43) Pub. Date: Aug. 10, 2023

(54) CONTAINERBOARD PRODUCTS INCORPORATING SURFACE ENHANCED PULP FIBERS AND MAKING THE SAME

(71) Applicant: Domtar Paper Company, LLC, Fort Mill, SC (US)

(72) Inventors: Harshad Pande, Pointe-Claire (CA); Lindsey Clifton, Fort Mill, SC (US)

(21) Appl. No.: 18/149,447

(22) Filed: Jan. 3, 2023

Related U.S. Application Data
(60) Provisional application No. 63/297,383, filed on Jan. 7, 2022.

(51) Int. Cl. D21H 15/02; D21H 11/00

(52) U.S. Cl. CPC D21H 15/02; D21H 5/14

(57) ABSTRACT

A containerboard can include a plurality of first fibers having a length weighted average fiber length that is greater than 0.5 mm, a plurality of second fibers having a length weighted average fiber length that is less than 2.0 mm, and a plurality of SEPF. The fiber length of the first fibers may be greater than the fiber length of the second fibers. The SEPF may include an average hydrodynamic specific surface area of at least 4.5 square meters per gram (m²/g) and comprise less than 10%, by weight, of the containerboard.

### CROSS-REFERENCE TO RELATED APPLICATIONS

This Application claims priority under 35 U.S.C. § 119(e) to U.S. Provisional Pat. Application No. 63/297,383, filed Jan. 7, 2022, the entire contents of which are fully incorporated herein by reference.

### FIELD OF INVENTION

The present invention relates generally to containerboard products and, more particularly, to containerboard products that incorporate surface enhanced pulp fibers.

### BACKGROUND

Containerboard is used for the manufacture and production of corrugated board and can include both linerboard and corrugated medium. Corrugated board is typically used in packaging applications, ranging from moving boxes to storing perishable food items. The containerboard used in making such corrugated products, such as corrugated shipping boxes, needs to be strong enough to withstand shipping, handling, and exposure to the elements. Further, to prevent waste containerboard can often be produced from recycling old corrugated container (OCC). However, using OCC for the production of containerboard can be problematic as pulp strength is often decreased when using recycled products such as OCC.

### SUMMARY

There is a need in the art for containerboard products, particularly recycled containerboard, which can achieve a strength suitable for use in the production of corrugated products, such as shipping boxes. Further, it is also desirable for the containerboard to be lightweight to increase transportability and reduce shipping cost. There accordingly is a need in the art for containerboard that can achieve a better combination of basis weight and strength as compared to prior art products.

The present containerboard products–which can include, without limitation, linerboard and corrugating medium–address this need in the art by including surface enhanced pulp fibers (SEPF)–which can be highly fibrillated in a manner that significantly increases fiber surface area while mitigating reductions in fiber length–in addition to a plurality of unrefined or lightly fibrillated hardwood, softwood, non-wood, or recycled fibers, such as those from old corrugated containers/cardboard (OCC). Some such containerboard products can include a plurality of first fibers having a fiber length that is greater than 0.2 millimeters (mm), a plurality of second fibers having a fiber length that is less than 3.0 mm, and a plurality of SEPF.

Some of the present configurations include a containerboard that has a plurality of cellulosic pulp fibers. In some such configurations the fibers include a plurality of first fibers that have a length weighted average fiber length of at least 0.5 millimeters (mm); a plurality of second fibers that have a length weighted average fiber length of less than 1.5 millimeters (mm); and a plurality of surface enhanced pulp fibers (SEPF) having an average hydrodynamic specific surface area of at least 2.0 square meters per gram (m²/g). The fiber length of the first fibers may be greater than the fiber length of the second fibers. And, in some such configurations, the SEPF comprises less than 20%, by weight, of the containerboard.

In some aspects, the SEPF comprises less than or equal to 8%, by weight, of the containerboard. In other aspects, the SEPF comprises less than or equal to 4%, by weight, of the containerboard. In some configurations, each of the first fibers, the second fibers, and the SEPF comprise recycled OCC fibers. In some aspects, the first fibers comprise at least 50%, by weight, of the containerboard. The second fibers may include less than or 40%, by weight, of the containerboard. Additionally or alternatively, the first fibers can have a length weighted average fiber length that is greater than 1.5 mm, the second fibers have a length weighted average fiber length that is less than or equal to 1.4 mm (e.g., 1.3 mm), or both. In some aspects, the SEPF includes less than 10%, by weight, of the containerboard and the average hydrodynamic specific surface area of the SEPF is greater than 3.0 m2/g.

Some aspects of the present disclosure include a method of making a containerboard. The method may include making one or more sheets. In some configurations, the method may include for each of the sheets, forming a web from one or more furnishes. The furnishes include fibers dispersed in water, the fibers including: a plurality of first fibers having a fiber length greater than or equal to 0.5 mm; a plurality of second fibers having a fiber length less than or equal to 3.0 mm; and a plurality of surface enhanced pulp fibers (SEPF), wherein the SEPF are made by refining a pulp feed in a refiner such that the refiner consumes at least 300 kilowatt-hours (kWh) per ton of fiber in the pulp feed. Some such methods include forming a containerboard from the sheets. The fiber length of the first fibers is greater than the fiber length of the second fibers and the SEPF comprises less than 10%, by weight, of the containerboard.

In some methods, refining the plurality of SEPF includes refining the fibers at a specific edge load that is less than 0.85 Watt-seconds per meter (Ws/m) (e.g., 0.80 Ws/m). Additionally, or alternatively, refining the plurality of SEPF may include refining the SEPF at a specific energy that is greater than or equal to 500 kWh per ton, or greater than or equal to 400 kWh per ton. Some methods may include separating the first and second fibers from a recycled old corrugated cardboard (OCC) pulp. In some such configurations, the method may include pulping old corrugated cardboard (OCC) to form the OCC pulp. Additionally, or alternatively, the method can include: refining a portion of the plurality of first fibers to form the SEPF; refining a portion of the plurality of second fibers to form the SEPF; or both. In some methods, the first fibers comprise at least 50%, by weight, of the containerboard. In some methods; the second fibers comprise less than or equal to 40%, by weight, of the containerboard.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified – and includes what is specified; e.g., substantially 90 degrees includes 90 degrees and substantially parallel includes parallel – as understood by a person of ordinary skill in the art. In any disclosed configuration, the terms “substantially” and “approximately” may be substituted with “within [a percentage] of” what is specified, where the percentage includes 0.1, 1, 5, and 10 percent.

The terms “comprise” and any form thereof such as “comprises” and “comprising,” “have” and any form thereof such as “has” and “having,” and “include” and any form thereof such as “includes” and “including” are open-ended linking verbs. As a result, a product or system that “comprises,” “has,” or “includes” one or more elements possesses those one or more elements, but is not limited to possessing only those elements. Likewise, a method that “comprises,” “has,” or “includes” one or more steps possesses those one or more steps, but is not limited to possessing only those one or more steps. The terms “at least some” when used to modify components, may refer to a portion of the components, up to and including all of the components.

Any configuration of any of the products, systems, and methods can consist of or consist essentially of – rather than comprise/include/have – any of the described steps, elements, or features. Thus, in any of the claims, the term “consisting of” or “consisting essentially of” can be substituted for any of the open-ended linking verbs recited above, in order to change the scope of a given claim from what it would otherwise be using the open-ended linking verb.

Further, a device or system that is configured in a certain way is configured in at least that way, but it can also be configured in other ways than those specifically described.

The feature or features of one configuration may be applied to other configurations, even though not described or illustrated, unless expressly prohibited by this disclosure or the nature of the configurations.

Some details associated with the configurations described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1A is a top view of a configuration of the present paperboard.

FIG. 1B is a sectional view of the paperboard of FIG. 1A taken along line 1B-1B.

FIG. 1C is a perspective view of a configuration of a corrugated board product produced from the present paperboard.

FIG. 2 is a schematic diagram of a system for producing fibers of the present paperboard.

FIG. 3 is another schematic diagram of a system for producing fibers of the present paperboard.

FIGS. 4A and 4B are schematic diagrams of a first and second system, respectively, for producing the present paperboard.

FIG. 5 is a comparative graph of the bulk properties of five handsheets produced using the present processes.

FIG. 6 is a comparative graph of the breaking length of the five handsheets produced using the present processes.

FIG. 7 is a comparative graph of the stretch percentage of the five handsheets produced using the present processes.

FIGS. 8 and 9 are comparative graphs of the tensile energy absorption of the five handsheets produced using the present processes in the machine direction and cross direction, respectively.

FIG. 10 is a comparative graph of the burst index of the five handsheets produced using the present processes.

FIG. 11 is a comparative graph of the tear index of the five handsheets produced using the present processes.

FIG. 12 is a comparative graph of the porosity of the five handsheets produced using the present processes.

FIG. 13 is a comparative graph of the Scott bond of the five handsheets produced using the present processes.

FIG. 14 is a comparative graph of the compression strength of the five handsheets produced using the present processes.

FIG. 15 is a comparative graph of the ring crush of the five handsheets produced using the present processes.

FIG. 16 is a comparative graph of the Concora of the five handsheets produced using the present processes.

FIG. 17 is a comparative graph of the slide angle of the five handsheets produced using the present processes.

### DETAILED DESCRIPTION

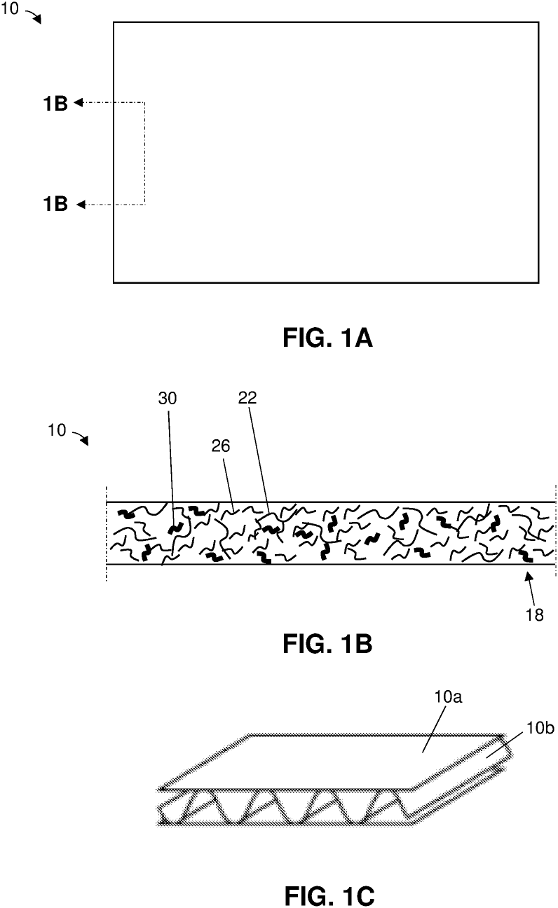

Referring to FIGS. 1A and 1B, shown is a first configuration 10 of the present paperboard products. Paperboard 10 can have a composition with high strength, rendering the paperboard suitable as a containerboard, such as linerboard or corrugating medium, for use in, for example, corrugated boxes or other corrugated board products. Paperboard 10 can comprise fibers 18, that may be cellulosic fibers, including hardwood fibers, such as fibers originating from oak, gum, maple, poplar, eucalyptus, aspen, birch, or the like; softwood fibers, such as fibers originating from spruce, pine, fir, hemlock, redwood, or the like; or non-wood fibers, such as fibers originating from kenaf, hemp, straws, bagasse, or the like. In some configurations, at least some of the fibers can be recycled fibers. For example, the fibers may comprise old corrugated containers (OCC) fibers from recycled OCC.

For example, as shown in FIG. 1B, paperboard 10 includes a plurality of first fibers 22 that can be long fibers–which can contribute to the strength of the containerboard product–and a plurality of second fibers 26 that can include short fibers and a plurality of highly fibrillated fibers 30, referred to herein as “surface enhanced pulp fibers” (SEPF). First fibers 22 have an average fiber length that is longer than a length of second fibers 26. As used herein, length refers to average fiber length (length weighted) unless otherwise specified. For example, first fibers 22 may be at least 15%, longer than a length of second fibers 26, such as 20% or 30% longer than the second fibers. In some configurations, second fibers 26 have a length that is less than, equal to, or between any two of: 1.0, 0.9, 0.8, 0.7, 0.6, 0.5, 0.4, or 0.3 mm and first fibers 22 have a length that is greater than 1.0 millimeters (mm), such as at least 1.1, 1.2, 1.5, 1.8, 2.0 mm or larger. In some configurations, a majority of first fibers 22 can be softwood fibers, a majority of the second fibers 26 can be hardwood fibers, or both. As a non-illustrative example, first fiber 22 can include or correspond to softwood fibers having an average fiber length that is greater than or equal to 1.6 mm after refining. Additionally, or alternatively, second fibers can include or correspond to hardwood fibers having an average fiber length that is less than or equal to 1.3 mm after refining. In other configurations, first fibers 22, second fibers 26, and highly fibrillated fibers 30 can be softwood fibers, hardwood fibers, non-wood fibers, or combination thereof.

First and second fibers 22, 26 can be unrefined or lightly refined as compared to highly fibrillated fibers 30. As a non-limiting example, first and second fibers can have an average hydrodynamic specific surface area that is less than any one of, or between any two of, 3 square meters per gram (m²/g), 2.5 m²/g, 2 m²/g, 1.5 m²/g, or 1 m²/g. SEPF 30 can have higher surface areas compared to conventionally-refined pulp fibers. For example, SEPF 30 can have an average hydrodynamic specific surface area that is greater than or equal to any one of, or between any two of, 4.5 m²/g, 5 m²/g, 6 m²/g, 7 m²/g, 8 m²/g, 9 m²/g, 10 m²/g, 12 m²/g, 14 m²/g, 16 m²/g, 18 m²/g, 20 m²/g, or larger. And, SEPF 30 can have a length weighted fines value that is less than or equal to any one of, or between any two of, 40%, 35%, 30%, 25%, 20%, 18% or less, when fibers having a length of 0.20 mm are classified as fines. A description of SEPF and processes by which SEPF can be made are set forth in further detail in U.S. Pat. Application No. 13/836,760, filed Mar. 15, 2013, and published as Pub. No. US 2014/0057105 on Feb. 27, 2014, which is hereby incorporated by reference. SEPF 30 can include long fiber SEPF 30a, short fiber SEPF 30b, or both, as described below. For example, long fiber SEPF 30a includes first fibers 22 that have been subjected to surface enhancement and short fiber SEPF 30b may include second fibers 26 that have been subjected to surface enhancement, as described herein.

As shown in FIG. 1C, paperboard 10, such as containerboard, can be used in the production of corrugated board products. In some configurations, paperboard 10 as described herein can be used as linerboard 10a or a corrugated medium 10b. In either configuration, paperboard 10 may include a plurality of first fibers 22, a plurality of second fibers, and a plurality of SEPF 30.

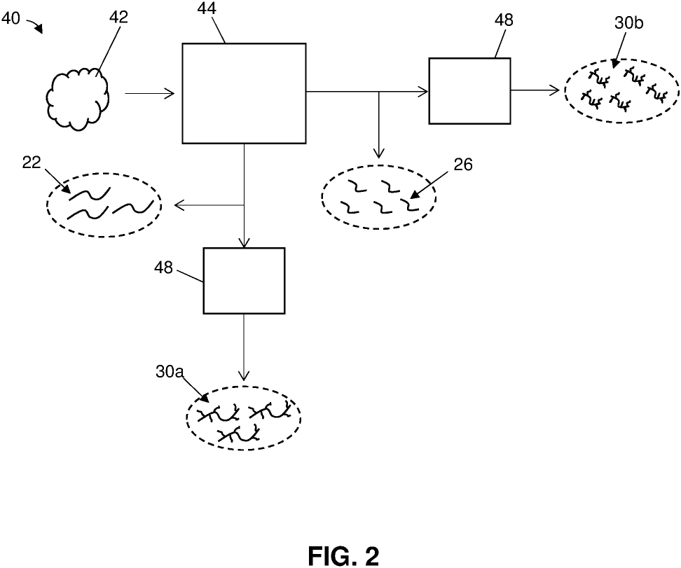

Referring now to FIG. 2, shown is an illustrative, schematic diagram of a system 40 that can be used to make at least some of fibers 18. While some methods are described with reference to system 40, system 40 is not limiting on those methods, which can be performed using any suitable system.

Some methods include a step of fractionating a pulp feed 42 to separate the pulp into long and short fiber fractions. Pulp feed 42 can comprise any of the cellulosic fiber types discussed above and, in some configurations, the pulp feed includes recycled fibers, such as fibers from OCC pulp. As an illustrative, non-limiting example, pulp feed 42 can be OCC pulp that includes both softwood–such as unbleached softwood Kraft from recycled linerboard–and hardwood fibers– such as semi-chemical hardwood from recycled corrugating medium. In some methods, pulp feed 42 includes a high amount of lignin containing fibers as compared to conventional pulp feed. For example, pulp feed 42 may include a Kappa number that is greater than or equal to 50, such as, for example, 60, 70, 75, 80 or greater.

Pulp feed 42 is fed into a fractionator 44 such as, for example, a Selectifier 8P screening system from Innofibre. Fractionator 44 may include one or more of screens, wires, boards, screening baskets, or the like and is configured to separate the pulp feed into long fibers, such as first fibers 22, and short fibers, such as second fibers 26. In some such configurations, the long fibers have a length at least 10% greater than a length of the short fibers. In an illustrative, non-limiting example, fractionator 44 is configured to separate pulp feed 42 into first fibers 22 having a length weighted average fiber length greater than 1.5 mm and second fibers 26 having a length weighted average fiber length less than or equal to 1.4 mm (e.g., 1.3 mm). Fractionator 44 may be operated in any suitable manner to separate the fibers, as described herein, and one or more parameters–such as the inlet pressure, outlet pressure, flow rate, speed of rotor, work, slot size, or the like–of the fractionator may be selected to perform such separation.

After separation, first fibers 22 and second fibers 26 can be transported to other machinery or stored for later use. For example, some methods further include a step of making the SEPF 30. As illustrated in FIG. 2, at least a portion of separated first fibers 22 are fed to a refiner 48 to produce first highly fibrillated fibers 30a (first SEPF) and a portion of second fibers 26 are fed to a refiner 48 to produce second highly fibrillated fibers 30b (second SEPF). Similar to first fibers 22 and second fibers 26, first SEPF 30a may have a length that is greater than a length of second SEPF 30b. However, in other configurations, first SEPF 30a may have a length that is less than or equal to second SEPF 30b based on the refining processes. For example, first SEPF 30a may include a plurality of highly fibrillated fibers, as compared to first fibers 22, having a length weighted average fiber length of 1.3 mm Additionally, or alternatively, second SEPF 30b include a plurality of highly fibrillated fibers, as compared to second fibers 26, having a length weighted average fiber length of 1.6 mm.

Refiner 48 can be a disk refiner, such as a single-disk refiner, a double-disk refiner, or a multi-disk refiner, in which the refining elements are refiner plates or a conical refiner in which the refining elements are conical refiner fillings. Fibers 22 and 26 can be refined at least by imparting compression and shearing forces on the fibers to increase the fibrillation, and thus the average hydrodynamic specific surface area, thereof. To facilitate a high degree of fibrillation while mitigating undesired reductions in fiber length, each of the refining elements can have a fine bar pattern and, optionally, the refiners can be operated at a low specific edge load (SEL) compared to conventional refining processes. For example, refiners 48 may be configured such that the refiners operate at a SEL that is less than or equal to any one of, or between any two of, 1.5 Watt-seconds per meter (W·s/m), 1.0 W·s/m, 0.50 W·s/m, 0.45 W·s/m, 0.40 W·s/m, 0.35 W·s/m, 0.30 W·s/m, 0.25 W·s/m, 0.20 W·s/m, 0.15 W·s/m, 0.10 W·s/m, or less.

Additionally, or alternatively, fibers 22, 26 can be refined using a large amount of refining energy, compared to conventional processes, to achieve a high degree of fibrillation. For example, refiners 48 may be configured such that the refiners operate at a specific energy between 200 and 1000 kilowatt-hours per ton (kWh/ton), such as, for example 300, 400, 500, 600, 700, or 800 Kwh/ton. The refining energy expended can depend at least in part on the type of pulp fibers in the pulp feed and the desired degree of fibrillation. Such refining energies can be reached in any suitable manner. For example, refiners 48 can consume, per ton of fiber less than or equal to any one of, or between any two of, 110 kWh, 100 kWh, 90 kWh, 80 kWh, 70 kWh, 60 kWh, 50 kWh, 40 kWh, 30 kWh, or less each time the fibers are passed through the refiner. To reach the total desired refining energy, the fibers can be recirculated through the refiner 48 or passed through multiple refiners 48 such that the cumulative energy consumed by the refiners reaches the desired level, such as at least 400, 500, or 600 kWh per ton of fiber. Although depicted in FIG. 2 as having a refiner 48 for each of the fibers 22, 26, in some configurations, first fibers 22 and second fibers 26 may be passed through the same refiner 48 at different times.

In some configurations, refining of the fibers 22, 26 can be performed to yield larger increases in the average hydrodynamic specific area of the SEPF precursor fibers than conventional refining processes while mitigating reductions in fiber length–such as at a low SEL, high refining energy, with fine bar pattern, or combination thereof. For example, the fibers 22, 26 can be refined such that the average hydrodynamic specific surface area of the fibers increases by at least 300%, while the length weighted average fiber length of the fibers decreases by less than 70%. The resulting SEPF can thereby have any of the above-described length weighted average fiber lengths and average hydrodynamic specific surface areas.

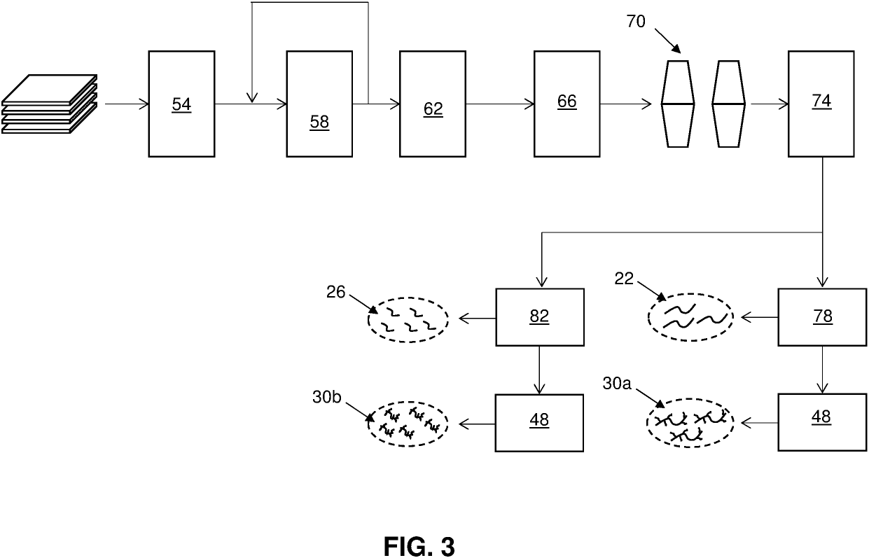

Referring now to FIG. 3, shown is an illustrative, schematic diagram of a system 50 that can be used to make at least some of fibers 18 from a recycled material 52, such as OCC. While some methods are described with reference to system 50, system 50 is not limiting on those methods, which can be performed using any suitable system.

Some methods include a step of feeding recycled material 52 into a pulper 54. Recycled material 52 can be OCC or other types of waste paper, including pre- or post-consumer waste, recycled paper, recycled fiber, or the like. As a specific, non-limiting example, recycled material 52 can be double lined Kraft (DLK). Pulper 54 is configured to produce pulp, such as a pulp feed from recycled material 52 or other material that includes cellulose fibers. In some configurations, pulper 54 can be a drum pulper, a hydrapulper, including D-type, H.C., M.C., or the like, broke pulper, or the like and can be batch or continuously operated.

In some methods, the pulp produced from pulper 54 is fed to a Hi-Density (HD) cleaner 58 that is configured to separate heavy rejects from the pulp. In some such methods, pulp may be passed through HD cleaner multiple times. HD cleaner 58 may be a centrifugal cleaner having a rotor that is configured to remove impurities with a specific gravity that is greater than a removal threshold, while allowing the lighter materials to continue through the process. For example, in some configurations, the pulp from HD cleaner 58 is sent through a coarse screen 62 that is configured to remove board and plastic flakes or other largely sized particles and contaminates, such as very coarse fibers, knots, shives, dirt and sand. Coarse screen 62 may define a plurality of screen holes that are sized to prevent passage of these particles. For example, coarse screen may have a screen hole diameter that is less than 4.00 mm, such as less than, equal to, or between any two of 3.00, 2.50, 2.00, 1.75, 1.60, 1.50, 1.40, 1.30, 1.20, or 1.00 mm, such as, for example 1.57 mm.

Some methods include a step of introducing the pulp into a paper machine tank 66. The paper machine tank may be configured to blend the fibers in the pulp and any other substance– such as, for example, treatments, additives, functional chemicals, and/or the like–that may be added to the tank. The pulp can then be sent through a cleaner 70, a slot screen 74, or both. Cleaner 70 may be a reverse hydrocyclone and is configured to remove lightweight contaminants or particles from the pulp, leaving only the cellulose fibers behind. The lightweight contaminants are lighter than the fibers and water of the pulp slurry and may include latexes, waxes, hot melts, Styrofoam, polypropylene, polyethylene, or the like. The remaining heavy fibers are discharged from cleaner 70 and can then be sent though slot screen 74 that is configured to separate the fibers based on the fiber length. For example, slot screen 74 can be configured to separate the fibers between short fiber pulp–pulp having second fibers 26–and long fiber pulp–pulp having first fibers 22.

Some methods include a step of thickening the pulp. For example, the short fiber pulp and long fiber pulp may be fed into sidehill screen 78, gravity decker 82, or other thickener. As illustrated in FIG. 3, long fiber pulp can be sent through sidehill screen 78, which may be a parabolic, gravity, sloped, or static screen, that is configured to remove water from the long fiber pulp slurry. Additionally, or alternatively, short fiber pulp can be sent through gravity decker 82 that is configured to remove water from the short fiber pulp slurry. Sidehill screen 78 and gravity decker 82 may include screens suitable for reducing the water content of the pulp. Sidehill screen 78 and gravity decker 82 may include at least one mesh screen that is sized between 8 and 50 U.S. Mesh. As an illustrative example, sidehill screen 78 or gravity decker 82 can include a 10 mesh wire, having a 1.7 mm hole opening, a 40 mesh wire, having a 0.425 mm hole opening, or both. Additionally, or alternatively, a 35 mesh wire could be used individually or in combination with one or more other mesh screens.

After thickening, the fibers 22, 26 can then be separated for storage or for further processing, such as in refiner 48, or mixing, such as into furnish 104a. In some methods, at least some of first fibers 22, second fibers 26, or both are transferred to refiner to make SEPF 30. Refiner 48 can be the same or different from the refiner of system 40. In some configurations, refiner 48 can include one or more plates that are sized based on the length of the fiber. For example, in configurations using 1.3 mm × 2.4 mm or 1 mm × 1.3 mm plate sizes, the 1 mm × 1.3 mm plates may be used for short fibers of less than 1.0 mm and the 1.3 × 2.4 plates may be used for fibers above 1.0 mm. SEPF 30a produced from first fibers 22 and SEPF 30b produced from second fibers 26 can have the same properties as described above.

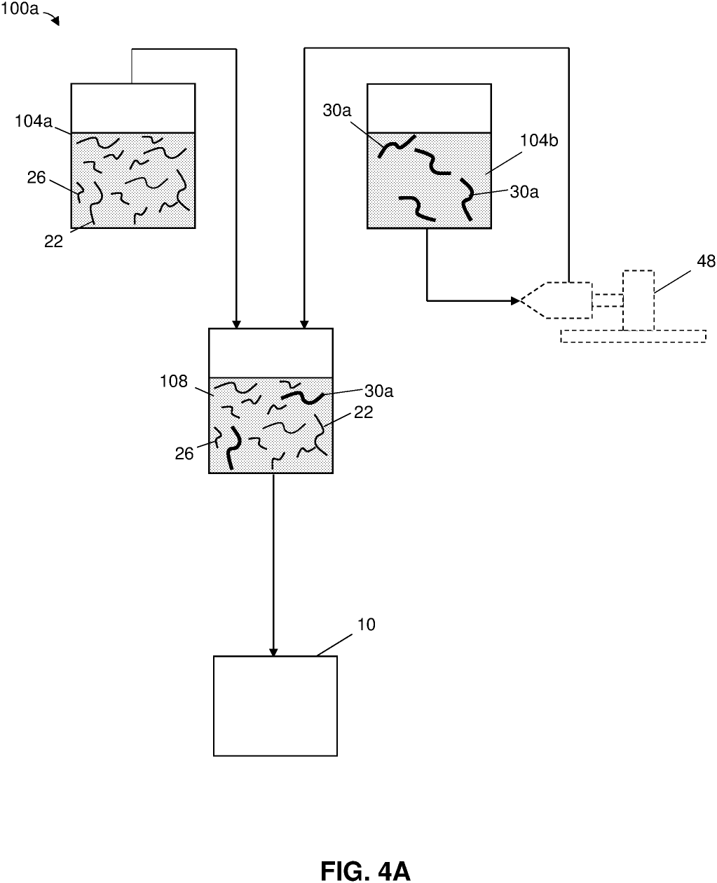

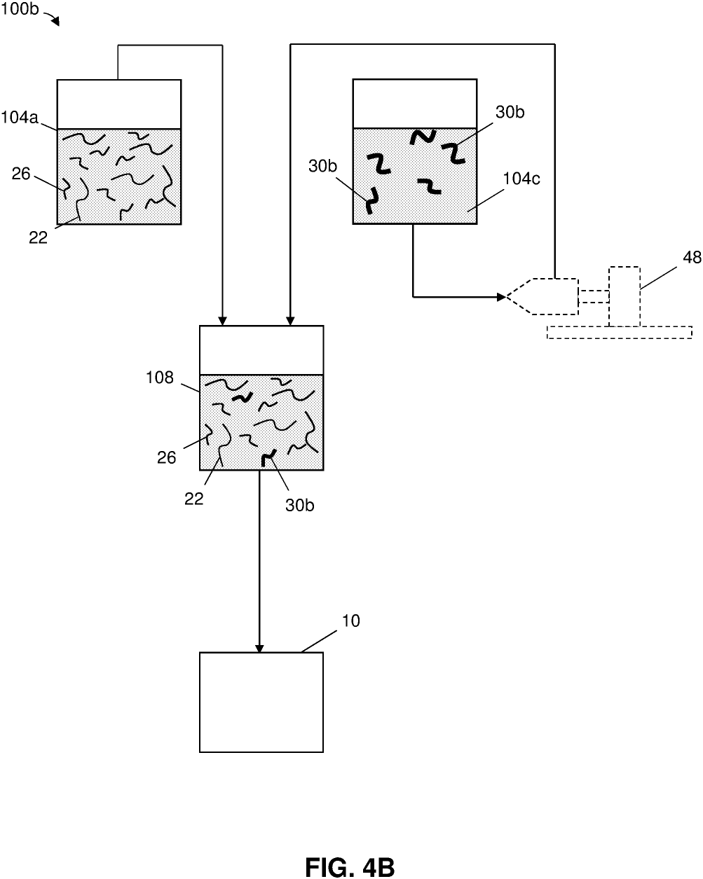

Referring now to FIGS. 4A and 4B, some of the present methods include the making of a paper product, such as paperboard products, containerboard products, or the like. Some such methods may be carried out via a system 100a or a system 100b, as depicted in FIGS. 4A and 4B, respectively. Components of systems 100a, 100b may include or correspond to one or more components of systems 40, 50 described above.

Some methods of making paperboard 10 can include a step of making one or more sheets, each of which can define the paperboard 10 or can define a respective ply of the paperboard 10. Each of the sheets can be made using one or more furnishes, such as the furnishes described below. The furnish(es) can comprise fibers 18, such as cellulosic fibers dispersed in water, including hardwood fibers, softwood fibers, or non-wood fibers. In some configurations, at least some of the fibers can be recycled fibers. The furnishes can include a plurality of first fibers 22, a plurality of second fibers 26, and a plurality of highly fibrillated fibers, such as SEPF 30a, 30b.

For example, as shown in FIGS. 4A and 4B, the furnishes can comprise a first furnish 104a that includes first fibers 22 and second fibers 26. First furnish 104a may be a selected mixture of first and second fibers 22, 26. As an illustrative, non-limiting example, first furnish 104a can include, by weight, between 50-80%, such as at least 50, 55, 60, 65, 70, or 75% first fibers 22 and between 20-50%, such as less than 20, 25, 30, 40, 45, 50 second fibers 26. For example, first furnish 104a may comprise, by weight, 65% of first fibers 22 and 35% of second fibers 26. In other configurations, first and second fibers 22, 26 may be included in a proportion such that paperboard 10 has a suitable strength for its intended application, such as containerboard. For example, strength, such as tensile strength, can be positively correlated with the proportion of the first fibers 22 in paperboard 10, while softness can be positively correlated with the proportion of the second fibers 26 in the paperboard.

First furnish 104a can be mixed with SEPF 30 to produce a containerboard furnish 108 which leads to improved strength properties of paperboard 10, like compression strength (STFI), flat crush resistance (Concora), burst strength, or the like. For example, in some configurations, such as that shown in FIG. 4A, first furnish 104a may be mixed with a second furnish 104b that includes SEPF 30a. Additionally, or alternatively, as shown in FIG. 4B, first furnish 104a may be mixed with a third furnish 104c that includes SEPF 30b. In such configurations, containerboard furnish 108 includes less than 15%, by weight, of SEPF 30, such as less than or equal to 12, 10, 8, 6, 4, 3, or 2% of the SEPF by weight. For example, containerboard furnish 108 may include 96%, by weight, first and second fibers 22, 26 and 4%, by weight, of SEPF 30, including SEPF 30a, 30b, or both. In another example, containerboard furnish 108 may include 92%, by weight, first and second fibers 22, 26 and 8%, by weight, of SEPF 30. In yet other configurations, containerboard furnish 108 may a suitable proportion of first fibers 22, second fibers 26, and SEPF such that paperboard 10 has a suitable strength for its intended application.

Some methods comprise a step of refining at least some of the furnishes with one or more refiners, such as refiner 48. For example, as shown the second and third furnish 104b, 104c can be beaten with one or more mechanical refiners to fibrillate, or further fibrillate, SEPF 30. Each of the mechanical refiners can be refined, as described above, by any suitable refiner, such as, for example, a double disk refiner, a conical refiner, a single disk refiner, a multi-disk refiner, a conical refiner, or the like. Second and third furnish 104b, 104c can also be refined chemically in addition to or instead of mechanical refining, such as with one or more enzymes, such as cellulases or xylanases. Although, second furnish 104b and third furnish 104c are depicted as, optionally, passing through refiner 48, in other configurations, SEPF 30a of the second furnish or SEPF 30b of the third furnish may already be refined–such as for example as described above for systems 40, 50–and mixed directly with first furnish 104a. In some configurations, first fibers 22 and second fibers 26 of first furnish 104a can be lightly refined, as compared to SEPF 30.

Paperboard 10 formed from containerboard furnish 108 having such proportions of the first and second fibers and SEPF can be stronger than otherwise similar products that do not comprise SEPF. The inclusion of the SEPF in the furnishes can yield a paper product with higher strengths than otherwise comparable products at least in part because of the comparatively higher fibrillation and high surface areas of the SEPF. The large hydrodynamic specific surface area of the SEPF, for example, can promote chemical bonding. Such improved strength characteristics may allow for a reduction in basis weight of paperboard 10 while having the same or greater strength as conventional paperboard.

Paperboard 10 can be formed from containerboard furnish 108 in any suitable manner. For example, containerboard furnish 108 can be deposited onto one or more moving surfaces to form one or more sheets that define the paperboard or are combined together, such as via layering, lamination, or both, to form the paperboard. Some methods can include dewatering the sheets, pressing, calendaring, embossing, laminating, rolling, cutting, packaging, or combination thereof.

### EXAMPLES

The present invention will be described in greater detail by way of specific examples. The following examples are offered for illustrative purposes only and are not intended to limit the present invention in any manner. Those skilled in the art will readily recognize a variety of non-critical parameters that can be changed or modified to yield essentially the same results.

### Example 1

Long and short fiber fractions from a batch of OCC having a kappa of around 78 were refined at various specific energies with refiner plates to determine the energy at which fibers developed best. TABLE 1, below, sets forth the fiber length and fines found using Fiber Quality Analyzer (FQA) for four samples taken from the OCC.

TABLE 1

OCC Fiber Properties

| | | | | | |
|---|---|---|---|---|---|
| Sample | | 1 | 2 | 3 | 4 |
| Fiber Length (mm) | Mean Length Weighted | 1.44 | 1.43 | 1.44 | 1.44 |
| Fines (0.07-0.20 mm) | Arithmetic | 44.58 | 41.5 | 41.10 | 41.38 |
| | Length Weighted | 9.34 | 8.45 | 8.31 | 8.23 |

As shown, the fiber properties were consistent across all four samples. Thus, any differences found in further testing are unlikely to be attributed to variation of the fibers in the OCC samples. The OCC was pulped, cleaned, fractionated, and refined at various refiner energies to produce both short fiber SEPF handsheets and long fiber SEPF handsheets. The handsheets were then measured and tested. As used in Example 1, Short SEPF refers to the short fiber fractions from the OCC batch that have been refined and Long SEPF refers to the long fiber fractions from the OCC batch that have been refined. The results of which are shown in TABLE 2, below.

TABLE 2

SEPF Fiber Properties at Varying Specific Energies

| Fraction | Specific Energy (Kwh/ton) | Schopper Riegler (SR) | Fines - Lw (%) (L= 0.07-0.20 mm) | Lw (mm) (L= 0.07-10.0 mm) |
|---|---|---|---|---|
| Short SEPF (@ 0.5 Ws/M) | 0 | 21 | 7.3 | 1.38 |
| | 400 | 88 | 18.3 | 0.60 |
| | 500 | 89 | 27.0 | 0.42 |
| | 600 | 90 | 34.0 | 0.36 |
| Long SEPF (@ 0.74-0.84 Ws/M) | 0 | 14 | 5.4 | 1.66 |
| | 400 | 85 | 16.1 | 0.76 |
| | 500 | 87 | 19.8 | 0.59 |
| | 600 | 89 | 27.3 | 0.42 |
| | 700 | 90 | 25.3 | 0.45 |

As shown in TABLE 2, 500 kwh/ton short fiber had better SR and fiber properties as compared to the fibers refined at other specific energies. Further, the short SEPF includes better properties than the Long SEPF at the 500 kwh/ton specific energy. All short fiber SEPF fractions performed better compared to long fiber in Concora, STFI, Burst, and Breaking Length. Further, testing was done to compare the mixture of unrefined OCC fibers (“Control fibers”)–having, by weight, 65% long fiber & 35% short fiber–with Short SEPF and Long SEPF. The Short SEPF was prepared by refining OCC short fibers—fibers having a length weighted average less than 1.4 mm–at a SEL of 0.5 Ws/m and a specific energy of 500 KWh/ton. The Long SEPF was prepared by refining OCC long fibers–fibers having a length weighted average fiber length less than or equal to 1.7 mm–at a SEL between 0.7-0.8 Ws/m and a specific energy of 500 KWh/ton. The results with long and short SEPF fibers are shown in TABLE 3, below.

TABLE 3

Comparison of Control Fibers and SEPF

| | OCC inlet to refiner | Short SEPF | Long SEPF |
|---|---|---|---|
| Fiber Length (Lw, mm) | 1.08 | 0.33 | 0.31 |
| Fines (arithmetic, %) | 86.8 | 88.4 | 89.0 |
| Fines (width <10 µm, length > 0.2 mm) | 6.4 | 13.3 | 13.1 |
| Fibrillation (%) | 0 | 76% | 67% |

As shown, the Short SEPF can have a length that is slightly greater than the length of the Long SEPF. This difference results from the difference in refining condition; specifically, the lower SEL, which results in less cutting of the fibers during refining. Both Short SEPF and Long SEPF resulted in increased fiber fibrillation, with the refined high lignin OCC fibers having 67-76% higher fibrillation compared to the control fibers. For this reason and other reasons explained herein, such highly fibrillated fibers would allow for a reduction in basis weight without sacrificing strength.

### Example 2

Several square handsheets were made with the OCC fiber mixture having, by weight, 65% long fiber & 35% short fiber and short fiber SEPF refined at a SEL of 0.5 Ws/m and a specific energy of 500 KWh/ton. To produce the handsheets containing SEPF, a certain percentage, by weight, was added to the OCC fiber mixture—having 65% long fiber & 35% short fiber. The basis weight was varied for some of the SEPF handsheets to determine if the basis weight for the SEPF handsheets could be decreased without sacrificing strength. Five handsheets were made and tested, including: 1) an OCC control sheet without SEPF having a basis weight of 150 grams per square meter (gsm); 2) a second sheet containing 4% SEPF, by weight, and having a basis weight of 150 gsm; 3) a third sheet containing 4% SEPF, by weight, and having a basis weight of 144 gsm; 4) a fourth sheet containing 8% SEPF, by weight, and having a basis weight of 150 gsm; 5) a fifth sheet containing 8% SEPF, by weight, and having a basis weight of 136.5 gsm. Each sheet was formed using a Formette Dynamique with a Jet to wire ration (j:w) of 1.0. TABLE 4, below, shows the morphological properties of the control sheet (0% SEPF), the 4% SEPF, and the 8% SEPF handsheets.

TABLE 4

Handsheet Fiber Properties

| | OCC Control Sheet | 4% SEPF Sheet | 8% SEPF Sheet |
|---|---|---|---|
| Freeness, mL | 466 | 420 | 386 |
| Fiber Length (LW), mm | 1.42 | 1.40 | 1.32 |
| Fiber Length (Arithmetic), mm | 0.58 | 0.57 | 0.51 |
| Fines (LW), % | 7.66 | 7.96 | 9.66 |
| Fines (Arithmetic), % | 37.90 | 38.26 | 41.50 |

In addition to the morphological changes shown by the addition of SEPF, it was also noticed that drainage of the the 8% SEPF handsheet was much slower than the control sheet. The 4% SEPF handsheet did not appear to have any difference in drainage as compared to the control sheet.

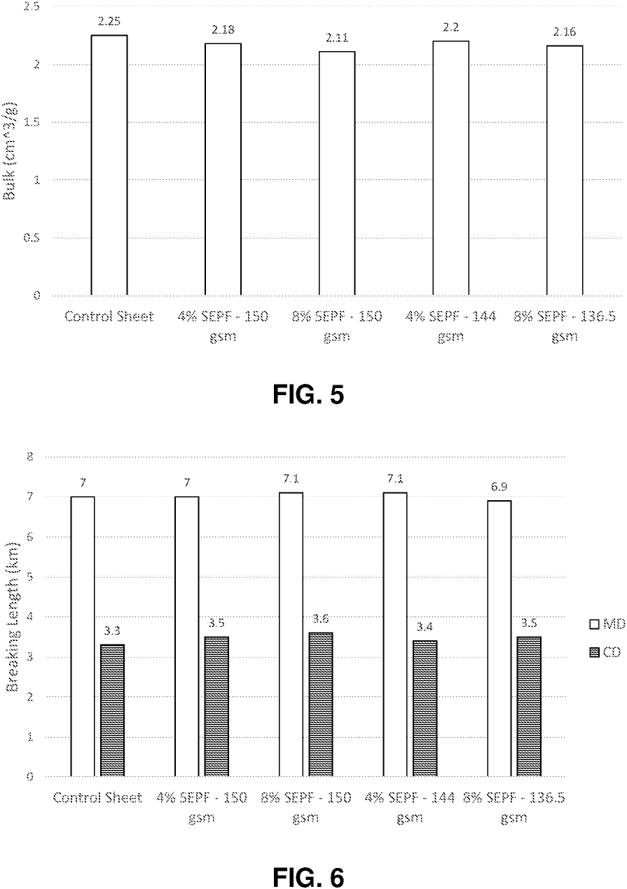

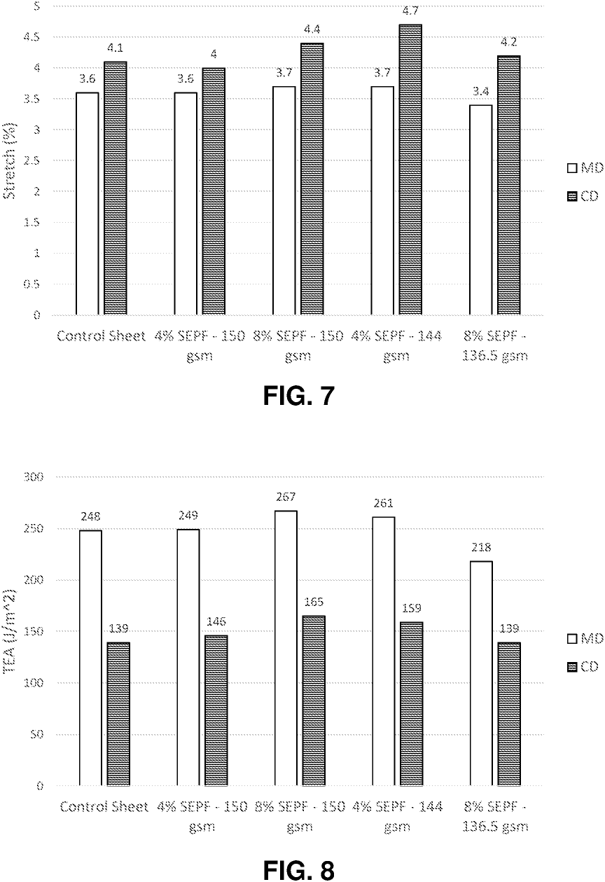

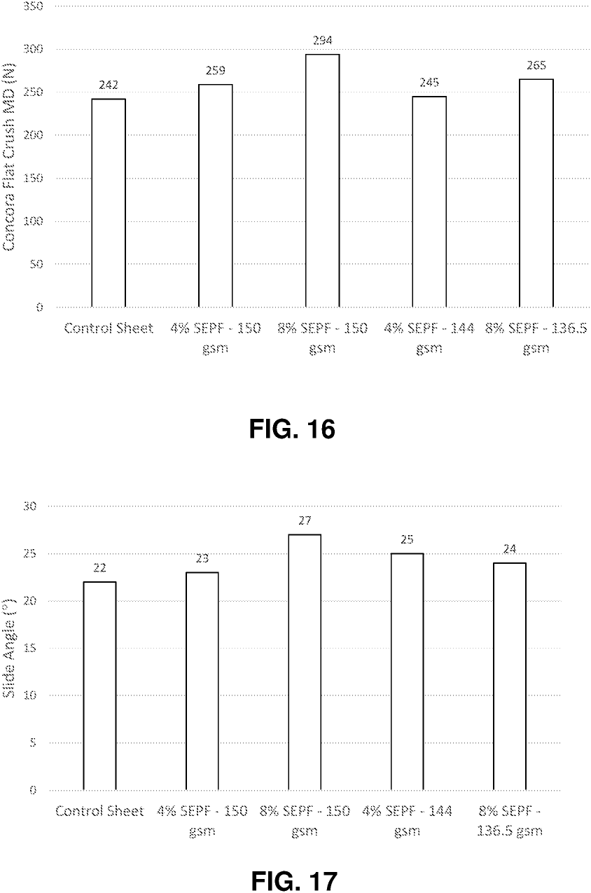

Referring now to FIGS. 5-17 a comparison of the physical characteristics of the handsheets was performed. As shown in FIG. 5, the addition of SEPF fibers tends to decrease bulk. However, even with removal of basis weight, the SEPF handsheets still provide similar bulk to the control sheet. FIG. 6 shows the breaking length is maintained in both the machine direction (MD) and cross direction (CD) despite the reduction in basis strength. Similarly, FIG. 7 illustrates that stretch may also be maintained in both the MD and CD at a reduced basis weight with the inclusion of SEPF.

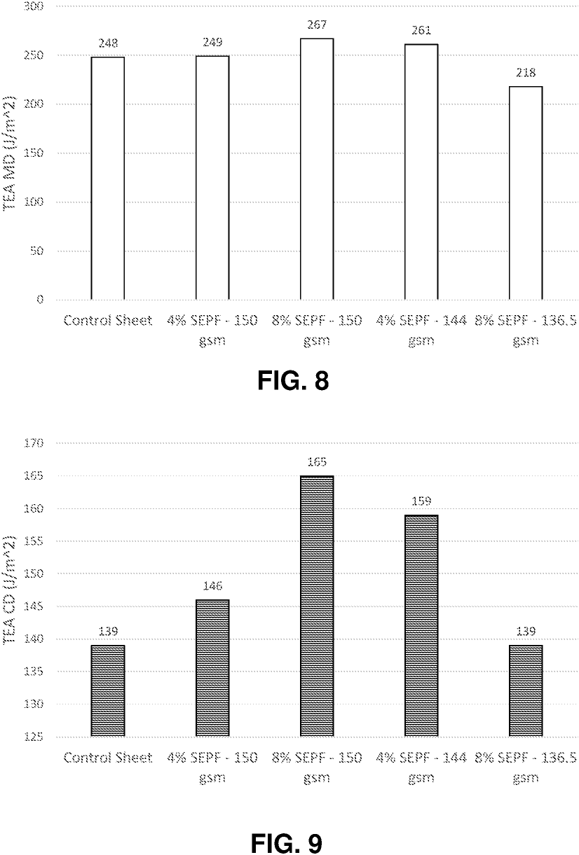

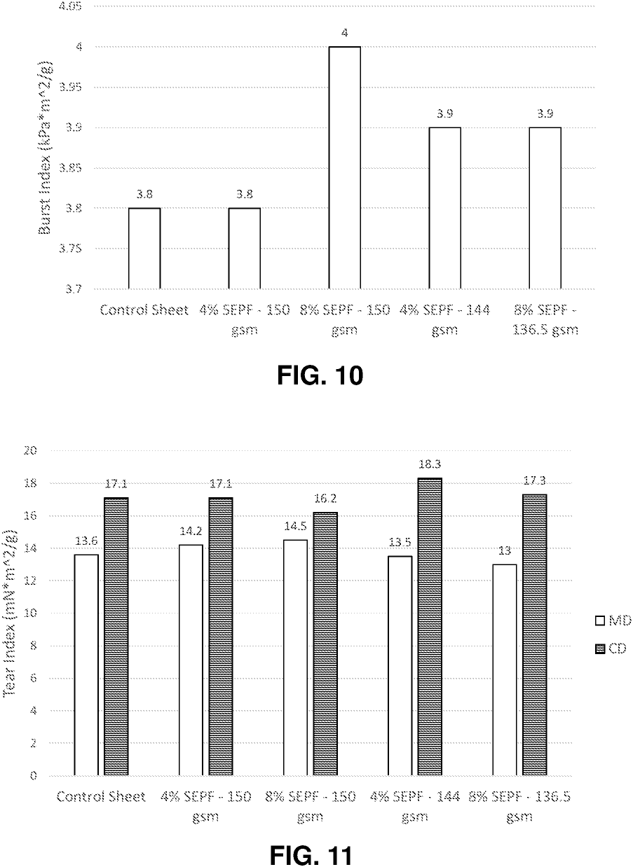

FIGS. 8 and 9 show tensile energy absorption (TEA) in both the MD and CD, respectively, and TEA is improved with SEPF addition. Referring now to FIG. 10, burst is slightly increased for all SEPF handsheets as compared to the control sheet. FIG. 11 shows the tear index for each handsheet in both the MD and CD. Tear index is typically fiber length dependent and no significant effect on 4% SEPF addition, while at 8% addition, we see a decrease.

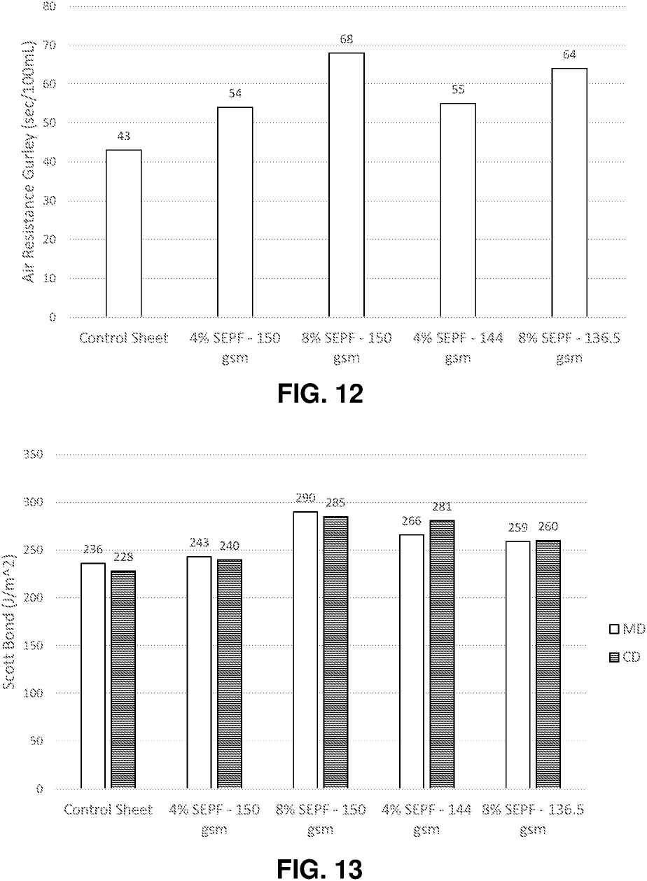

FIG. 12 shows the porosity of each handsheet, measured in sec/100 milliliter (mL). There is a clear relationship between porosity and the inclusion of SEPF, with the maximum air resistance (porosity) at 8% SEPF addition. Additionally, as shown in FIG. 13, Scott Bond is increased for the SEPF handsheets in both MD and CD as compared to the control sheet.

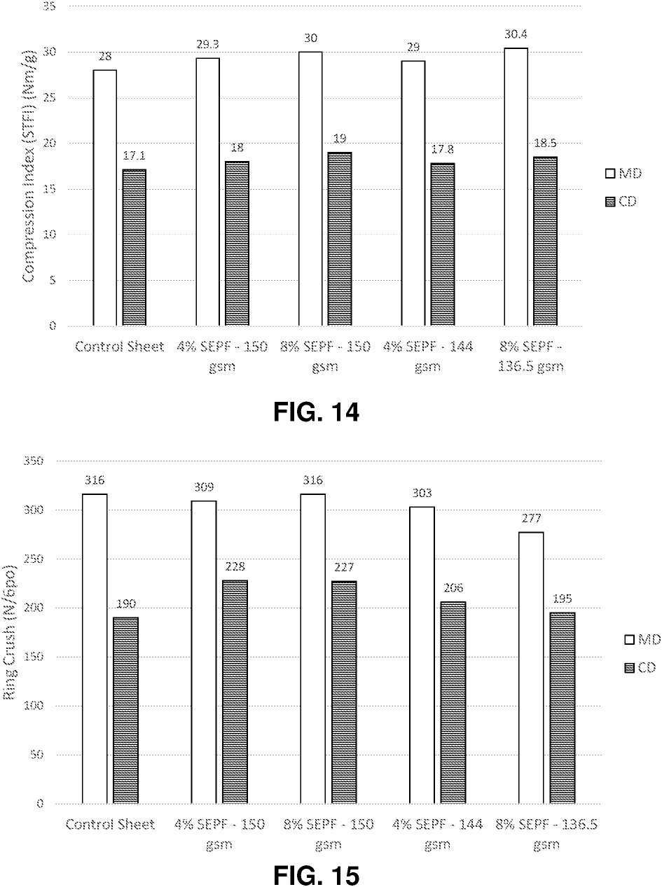

Referring now to FIGS. 14-16, the strength properties of the handsheets for compression strength (STFI), ring crush, and flat crush resistance (Concora) are shown, respectively. Both compression strength and Concora were increased significantly from the addition of SEPF even with a reduction in basis weight. The effects of SEPF on ring crush are not as significant. Thus, strength properties for the SEPF added handsheets are the same or improved for 4% addition of SEPF with reduced basis weight.

As shown in FIG. 17, slide angle is increase for all the SEPF handsheets. As depicted in FIGS. 5-17 mixing SEPF with OCC fibers allows for the production of sheets, such as paperboard 10, that have similar or improved properties as compared to sheets formed from the OCC fibers alone. Further, the addition of SEPF enables a reduction in basis weight without sacrificing other physical properties, such as compression strength, Concora, and Burst. Thus, the paperboard 10 produced as described herein can be light weight and have the same or increased strength properties as compared to conventional paper products, such as containerboard.

The above specification and examples provide a complete description of the structure and use of illustrative configurations. Although certain configurations have been described above with a certain degree of particularity, or with reference to one or more individual configurations, those skilled in the art could make numerous alterations to the disclosed configurations without departing from the scope of this invention. As such, the various illustrative configurations of the products, systems, and methods are not intended to be limited to the particular forms disclosed. Rather, they include all modifications and alternatives falling within the scope of the claims, and configurations other than the one shown may include some or all of the features of the depicted configuration. For example, elements may be omitted or combined as a unitary structure, or connections may be substituted. Further, where appropriate, aspects of any of the examples described above may be combined with aspects of any of the other examples described to form further examples having comparable or different properties or functions, and addressing the same or different problems. Similarly, it will be understood that the benefits and advantages described above may relate to one configuration or may relate to several configurations.

The claims are not intended to include, and should not be interpreted to include, means-plus- or step-plus-function limitations, unless such a limitation is explicitly recited in a given claim using the phrases “means for” or “step for,” respectively.

1. A containerboard comprising:
a plurality of cellulosic pulp fibers comprising:
a plurality of first fibers that have a length weighted average fiber length of at least 0.5 millimeters (mm);
a plurality of second fibers that have a length weighted average fiber length of less than 1.5 millimeters (mm); and
a plurality of surface enhanced pulp fibers (SEPF) having an average hydrodynamic specific surface area of at least 2.0 square meters per gram (m²/g); wherein:
the fiber length of the first fibers is greater than the fiber length of the second fibers; and
the SEPF comprises less than 20%, by weight, of the containerboard.

2. The containerboard of claim 1, wherein the SEPF comprises less than or equal to 8%, by weight, of the containerboard.

3. The containerboard of claim 2, wherein the SEPF comprises less than or equal to 4%, by weight, of the containerboard.

4. The containerboard of claim 1, wherein each of the first fibers, the second fibers, and the SEPF comprise recycled OCC fibers.

5. The containerboard of claim 1, wherein the first fibers comprise at least 50%, by weight, of the containerboard.

6. The containerboard of claim 5, wherein:
the second fibers comprise less than or equal to 40%, by weight, of the containerboard;
the first fibers have a length weighted average fiber length that is greater than 1.5 mm; and
the second fibers have a length weighted average fiber length that is less than or equal to 1.5 mm.

7. The containerboard of claim 5, wherein the SEPF comprises less than 10%, by weight, of the containerboard and the average hydrodynamic specific surface area of the SEPF is greater than 3.0 m2/g.

8. A method of making a containerboard, the method comprising:
making one or more sheets at least by, for each of the sheets:
forming a web from one or more furnishes that comprise fibers dispersed in water, the fibers of the furnishes comprising:
a plurality of first fibers having a fiber length greater than or equal to 0.5 mm
a plurality of second fibers having a fiber length less than or equal to 3.0 mm; and
a plurality of surface enhanced pulp fibers (SEPF), wherein the SEPF are made by refining a pulp feed in a refiner such that the refiner consumes at least 300 kilowatt-hours (kWh) per ton of fiber in the pulp feed; and
forming a containerboard from the sheets wherein:
the fiber length of the first fibers is greater than the fiber length of the second fibers; and
the SEPF comprises less than 10%, by weight, of the containerboard.

9. The method of claim 8, further comprising refining the plurality of SEPF at a specific edge load that is less than 0.85 Watt-seconds per meter (Ws/m).

10. The method of claim 9, where the plurality of SEPF are refined at a specific energy that is greater than or equal to 400 kWh per ton.

11. The method of claim 8, further comprising separating the first and second fibers from a recycled old corrugated cardboard (OCC) pulp.

12. The method of claim 11, further comprising pulping old corrugated cardboard (OCC) to form the OCC pulp.

13. The method of any of claim 11, further comprising refining a portion of the plurality of first fibers to form the SEPF.

14. The method of claim 11, further comprising refining a portion of the plurality of second fibers to form the SEPF.

15. The method of claim 8, wherein:
the first fibers comprise at least 50%, by weight, of the containerboard; and
the second fibers comprise less than or equal to 40%, by weight, of the containerboard.
